(19) United States
(12) Patent Application Publication
(10) Pub. No.: US 2008/0267378 A1
(43) Pub. Date: Oct. 30, 2008

(54) Conference System

(75) Inventors: Cornelis Pieter Janse, Eindhoven (NL); Cheng Chao Tchang, Bavel (NL); Abraham Janssens, Breda (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,170

(22) PCT Filed: May 20, 2005
(86) PCT No.: PCT/IB05/51647

§ 371 Date: Nov. 16, 2006

(30) Foreign Application Priority Data
May 25, 2004 (EP) 04102274.0

(51) Int. Cl. H04M 3/42

(52) U.S. Cl. 379/202.01

(57) ABSTRACT

A conference system (1) comprises a central unit (2) and speaker units (3) which are connectable to the central unit. The central unit (2), which serves to combine speech signals from the speaker units (3) and to distribute the combined speech signals to said units, comprises an adaptive filter (23) for suppressing feedback. Each speaker unit (3) comprises a microphone (33), a loudspeaker (34), an activation switch (35) and an adaptive filter (36) coupled between the microphone (33) and the loudspeaker (34). When the speaker unit is not activated, the adaptive filter (36) serves as an echo canceller, while serving as a feedback suppressor when the speaker unit is activated. By keeping the loudspeaker (34) always on, any transients due to mis-adaptations of the filter (36) are avoided.

The present invention relates to a conference system. More in particular, the present invention relates to a conference system comprising a central unit and at least one speaker unit that may be coupled to the central unit. The speaker units each comprise a loudspeaker and a microphone to allow a delegate to participate in a conference. The central unit combines the microphone signals from all speaker units and distributes the combined microphone signal to all speaker units, typically but not necessarily after amplification of this combined signal. The loudspeakers of the speaker units, or equivalent transducers, render this combined signal.

Although conference systems are traditionally used at conferences and congresses, the same technology is now also being used in cars, airplanes and other vehicles where several people want to converse in the presence of background noise.

It is noted that conference systems differ from public address systems in that a conference system uses multiple microphones at multiple, distinct positions (that is, in front of each delegate) for producing distinct signals, only one or two of which are selectively rendered. While public address systems also use multiple loudspeakers, there is no selective rendering of microphone signals in public address systems.

U.S. Pat. No. 5,404,397 discloses a conference system comprising speaker units coupled to a central unit. This known conference system is provided with automatic speaker detection. To this end, the central unit compares the speech signals of the speaker units and activates the unit(s) having the highest signal level. To avoid any erroneous speaker detection due to sound produced by other speakers, each speaker unit comprises an echo canceller provided with an adaptive filter. Upon activation of the speaker unit, the loudspeaker of the unit is switched off and the echo canceller is bypassed.

It has been found that switching off the loudspeaker, although very effective for suppressing undesired acoustic feedback from the loudspeaker to the microphone of the speaker unit, introduces signal distortion. Every time the loudspeaker is switched on and off, the sound pattern detected by the microphone and processed by the echo canceller changes: the acoustic path between the loudspeaker and the microphone is alternatingly added and removed. This implies that every time the speaker unit is (de)activated the echo canceller, in particular its adaptive filter, has to adapt to the changes in the acoustic paths. This leads to transient signals, that is, temporary signals which are not compensated by the echo canceller and therefore distort the (echo compensated) microphone signal. Transients occur in particular when the loudspeaker of the known speaker unit is re-activated. Transients may also occur in neighboring speaker units, whose microphones directly record the sound produced by the re-activated loudspeaker.

It has further been found that a significant part of the acoustic feedback recorded by the microphone of an active speaker unit originates from the loudspeaker(s) of the neighboring speaker units. This reduces the maximum allowable gain of the conference system as this acoustic feedback induces howling.

It is an object of the present invention to overcome these and other problems of the Prior Art and to provide a conference system in which transients due to the activation and de-activation of the speaker units are avoided.

It is another object of the present invention to provide a speaker unit and a central unit for use in such a conference system.

Accordingly, the present invention provides a conference system comprising at least one speaker unit and a central unit, the at least one speaker unit comprising an input for receiving loudspeaker signals, an output for supplying microphone signals, a loudspeaker coupled to the input, an adaptive filter coupled between the loudspeaker and a combination unit, a microphone coupled to the combination unit, and an activation device coupled between the combination unit and the output, the central unit comprising an input for receiving microphone signals and an output for supplying loudspeaker signals, wherein the loudspeaker of the at least one speaker unit is permanently coupled to its input, and wherein the central unit is provided with a further adaptive filter coupled between its input and its output.

By providing a loudspeaker that is permanently coupled to the input of the speaker unit and which therefore is permanently active, any transients caused by switching the loudspeaker on and off are avoided. As the loudspeaker typically renders the combined microphone signals of all active speaker units, it will almost continually produce sound which is recorded by the microphone. As a result, the adaptive filter of the speaker unit concerned will be able to adapt its filter parameters continuously to the same acoustic paths, leading to a stable filtering without transients.

By providing a further adaptive filter in the central unit any adverse effects of the loudspeaker remaining active are compensated. The further adaptive filter in the central unit serves as an acoustic feedback suppressor, removing any feedback from the output signal of the central unit to the input signal.

In a preferred embodiment, the central unit further comprises a decorrelator. Such a correlator, which may be arranged substantially in parallel with the adaptive filter, serves to remove any correlation between the input signal and the output signal of the adaptive filter. In the absence of a decorrelator, the adaptive filter would have the tendency to reduce the amplitude of the combined microphone signal and, possibly, introduce signal distortion. Preferably, the decorrelator is constituted by a frequency shifter. However, a phase shifter and/or a time-variable delay may also be used as a decorrelator.

The central unit may further comprise a dynamic echo suppressor, which serves to suppress the remaining echoes within the residual signal of an adaptive filter.

The time span of an adaptive filter may be defined as the product of the filter length (the number of delay units) and the sampling frequency. Although various time spans may be used, it is preferred that the adaptive filter of the speaker unit has a time span between 20 and 45 ms, preferably between 30 and 35 ms. In particular, a time span of approximately 32 ms is suitable. Such a relatively short time span results in an adaptive filter that is capable of converging quickly when the speaker unit is not active, as the microphone signals only contain echoes from other speaker units.

Although various types of adaptive filters may be used, it is preferred that the adaptive filter has an adaptation speed which is substantially proportional to an estimate of the echo to non-echo ratio (ENR) in the microphone signal when the echo to non-echo ratio is lower than a certain threshold value, a preferred threshold value being equal to one. In such an embodiment the filter reacts quickly when the microphone signal only contains echoes and slowly when the microphone signal contains a substantial non-echo signal component, for example the desired speech.

In a further preferred embodiment of the conference system according to the present invention the adaptive filter of the central unit has a time span ranging between 125 and 500 ms, preferably between 200 and 300 ms. A time span of approximately 250 ms is particularly preferred. In general, it is preferred that the time span of the (further) adaptive filter of the central unit is greater, preferably significantly greater, than the time span of the adaptive filter of the speaker unit(s). In this way, the adaptive filter of the speaker unit(s) is arranged for removing direct echoes, while the adaptive filter of the central unit is arranged for removing indirect or diffuse echoes.

The conference system of the present invention may advantageously be mounted in a vehicle, such as a car, bus or truck. The speaker units may be portable and provided with clips for clipping to the clothes of the speakers. However, the speaker units may also be built into the seats, ceiling, walls, floor or other parts of the vehicle.

The present invention also provides a speaker unit for use in the conference system as defined above, the speaker unit comprising an input for receiving loudspeaker signals, an output for supplying microphone signals, a loudspeaker coupled to the input, an adaptive filter coupled between the loudspeaker and a combination unit, a microphone coupled to the combination unit, and an activation device coupled between the combination unit and the output, wherein the loudspeaker is permanently coupled to the input.

The present invention additionally provides a central unit for use in the conference system as defined above, the central unit comprising an input for receiving microphone signals, an output for supplying loudspeaker signals, and a further adaptive filter coupled between its input and its output. The central unit of the present invention may further be provided with a decorrelator, a dynamic echo suppressor and/or an amplifier.

The present invention will further be explained below with reference to exemplary embodiments illustrated in the accompanying drawings, in which:

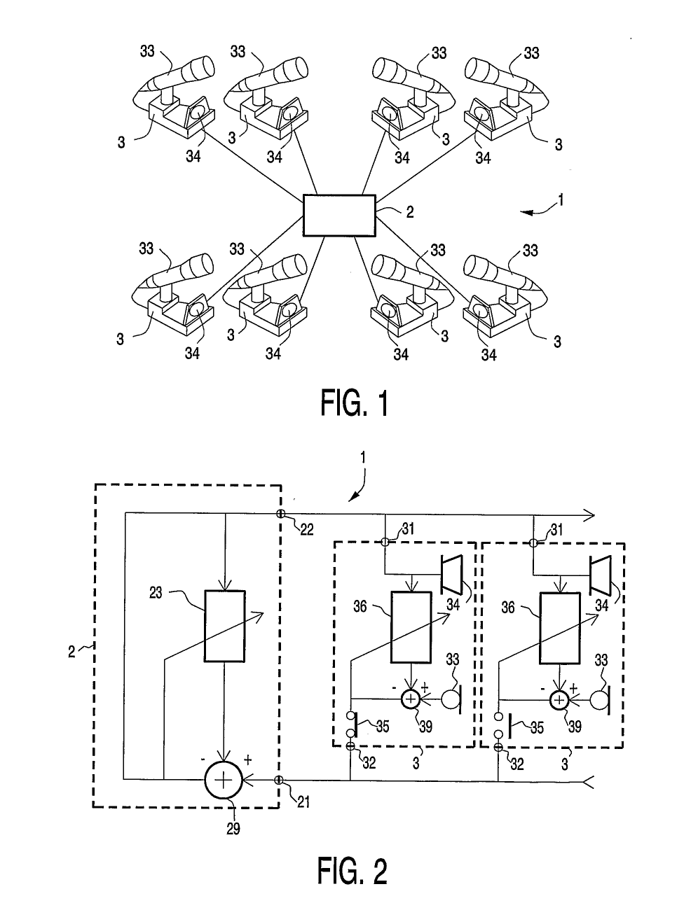

FIG. 1 schematically shows a typical conference system comprising speaker units and a central unit.

FIG. 2 shows a schematic circuit diagram of a conference system according to the present invention.

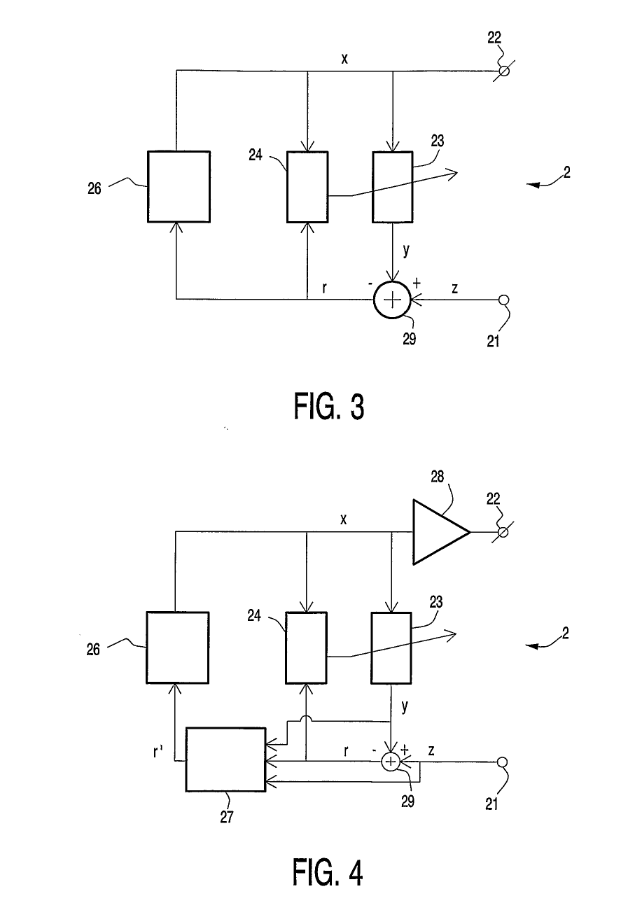

FIG. 3 shows a schematic circuit diagram of a first embodiment of a central unit according to the present invention.

FIG. 4 shows a schematic circuit diagram of a second embodiment of a central unit according to the present invention.

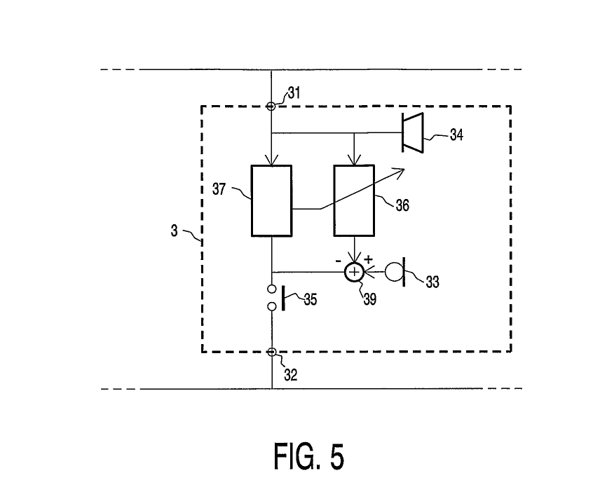

FIG. 5 shows a schematic circuit diagram of an embodiment of a speaker unit according to the present invention.

The conference system 1 shown merely by way of non-limiting example in FIG. 1 comprises a central unit 2 and speaker units 3. The central unit 2 serves to combine speech signals from the speaker units 3 and to distribute the combined speech signal to said units. Each speaker unit 3 comprises a microphone 33 for producing speech signals and a loudspeaker 34 for rendering the combined speech signal. Each speaker unit 3 may be provided with an activation button (not shown) for activating the microphone 33 of the unit. In typical conference systems the microphone 33 is normally off, only the speaker units activated by their users (traditionally called “delegates”) produce a speech signal.

The conference system of the present invention may be used in a conference room or conference hall, but may also be mounted in a vehicle, such as a car, bus, truck, airplane or boat. The speaker units may be portable and provided with clips for clipping to the clothes of the speakers (passengers and/or drivers/pilots). However, the speaker units may also be built into the seats, ceiling, walls, floor or other parts of the vehicle.

In the circuit diagram of FIG. 2 a conference system 1 according to the present invention is schematically illustrated. The conference system 1 of FIG. 2 also comprises a central unit 2 and two speaker units 3. Although only two speaker units 3 are shown, it will be understood that many more speaker units 3 may be connected to the central unit 2, for example four, eight, ten, or twenty-one speaker units.

The central unit 2 comprises an input 21 for receiving microphone signals from the speaker units 3, an output 22 for supplying loudspeaker signals (that is, combined, filtered and/or amplified microphone signals) to the speaker units 3, an adaptive filter 23 for filtering the microphone signals, and a combination unit 29 for combining the microphone signals and the filter signal, that is, the signal output by the filter 23.

The speaker units 3 each comprise an input 31 for receiving a loudspeaker signal, an output 32 for outputting a microphone signal, a loudspeaker 34 coupled to the input 31, an adaptive filter 36 coupled to the input 31 for receiving the loudspeaker signal, a microphone 33 for producing a microphone signal, a combination unit (signal adder) 39 for combining the microphone signal and the filter output signal, and a switch 35 for selectively connecting the combination unit 39 (and hence the microphone 33) to the output 32.

As is clear from FIG. 2, the speaker units 3 are arranged in parallel, each unit 3 being connected to the input 21 and the output 22 of the central unit 2. It will be understood that the output 32 of each speaker unit 3 may be connected to an individual input 21 of the central unit via an individual wire or other suitable connection. Thus the central unit 2 may have a plurality of inputs 21 which may all be connected to the combination unit 29.

The adaptive filter 23 of the central unit 2 serves as an acoustic feedback suppressor. The adaptive filter 23 models the acoustics paths present between the loudspeakers 34 and the microphones 33 of any active speaker units and outputs a signal that approximates the microphone signals produced by those acoustic paths. At the combination unit 29 this filter signal is subtracted from the microphone signals. The resulting signal r represents the “pure” microphone signals, that is, the signals produced by the speakers (“delegates”), not by the loudspeakers.

As the acoustic paths may change over time, for example due to the movement of people or articles within a conference room, the filter is adaptive: its filter coefficients are repeatedly or continuously adapted to best suit the acoustic paths at a particular point in time. Adaptive filters are well known, however, the Prior Art relating to conference systems fails to disclose or suggest a central unit provided with an adaptive filter.

In the conference system of the present invention, the speaker units 3 are also provided with adaptive filters. These adaptive filters 36 serve as an acoustic feedback suppressor (AFS) when the respective speaker unit is active and as an acoustic echo canceller (AEC) when the respective speaker unit is not active (those skilled in the art will understand that in the case of an AFS the loudspeaker signal is derived from the microphone signal of the speaker unit, while in the case of an AEC the loudspeaker signal is derived from an external signal).

As can be seen in FIG. 2, the adaptive filter 36 is arranged in parallel with the acoustic path extending from the loudspeaker 34 to the microphone 33. When the speaker unit is not active (switch 35 open), the microphone 33 records sound produced by the loudspeaker 34 of the speaker unit itself and by the loudspeakers of other speaker units. The speaker unit's adaptive filter 36 produces a filter signal that, when subtracted from the microphone signal at the combination unit 39, substantially cancels the sound from the loudspeaker 34 of the same speaker unit (acoustic echo cancellation, AEC). In addition, the filter signal typically also cancels the sound from the loudspeaker(s) of any neighboring speaker units that reaches the microphone directly, or indirectly via nearby objects. As will be explained later with reference to FIG. 5, the adaptive filter 36 attempts to remove any correlation between the loudspeaker signal and the microphone signal. Any correlation between these signals when the speaker unit is not active will be due to the microphone 33 picking up the sound of the loudspeaker(s) 34. When the speaker unit is not active, the adaptive filter 36 is able to react quickly and to model the acoustic path(s) accurately.

When the speaker unit 3 is active (switch 35 closed), the microphone signal is fed via the output 32 of the speaker unit 3 to the input 21 of the central unit where it is filtered by the central unit adaptive filter 23. In accordance with the present invention, the loudspeaker 34 remains active when the speaker unit is active. As a result, the sound produced by the loudspeaker 34 will now also contain the microphone signal, which significantly increases the correlation of the loudspeaker signal and the microphone signal. Both the speaker unit adaptive filter 36 and the central unit adaptive filter now act as acoustic feedback suppressors (AFS).

The adaptation speed of an AFS is low compared to the adaptation speed of an AEC. For an AEC the microphone signal only contains echoes, whereas for an AFS the microphone signal contains both echoes and the desired speech signal. Fast adaptation may in the case of an AFS lead to degradation of the desired speech.

In the conference system of the present invention, the combined action of the adaptive filters 23 and 36 removes the direct sound from the loudspeakers, the first reflections from nearby objects and any diffuse feedback from other objects. In addition, the speaker unit adaptive filter 36 perfectly cancels the direct sound and any first reflections when the speaker unit is activated, thus avoiding the introduction of any transients.

An alternative embodiment of the central unit 2 is shown in FIG. 3. This embodiment also comprises an input 21 for receiving a microphone signal z, an output 22 for supplying a loudspeaker signal x, an adaptive filter 23 for producing a filter signal y and a combination unit 29 for combining the signals z and y so as to produce a residual signal r. Additionally, the central unit 2 of FIG. 3 comprises an update unit 24 and a decorrelator 26. The update unit 24 receives both the residual signal r output by the combination unit 29 and the decorrelated signal x and determines the correlation of these two signals. The coefficients of the filter 23 are then adapted in such a way that said correlation is minimized. In the absence of decorrelator 26, the adaptive filter would attempt to suppress the residual signal z as the signals z and x would be substantially identical (it is noted that other signal processing elements may be present in the central unit 2 which are not shown in FIG. 3 for the sake of clarity). The decorrelator 26 is preferably constituted by a frequency shifter which shifts the frequency of the residual signal r by a few hertz. Instead of or in addition to a frequency shifter, the decorrelator 26 may comprise a phase shifter and/or a time-varying delay. The decorrelator 26 not only prevents signal distortion but also increases the adaptation speed of the adaptive filter 23.

The embodiment of the central unit 2 shown in FIG. 4 comprises, in addition to the components mentioned above with reference to FIG. 3, a dynamic echo suppressor (DES) 27 and an amplifier 28. The dynamic echo suppressor 27 receives the microphone signal z, the filter signal y and the residual signal r to produce a compensated residual signal r′. Such a dynamic echo suppressor serves to temporarily decrease the amplitude of the residual signal when changes in the acoustic path cause the acoustic feedback compensation signal produced by the adaptive filter to contain a phase error. Such changes in the acoustic path are typically introduced when speaker units are activated or de-activated. The dynamic echo suppressor therefore even further reduces any undesirable effects of speaker unit (de)activation.

The dynamic echo suppressor 27 modifies the amplitude of the frequency components of the input signal z without changing its phase (apart from a pure delay). This is achieved by determining the frequency spectrum (Fourier transform) of both the filter signal y, the input signal and the residual signal r so as to obtain transformed signals Y, Z and R, determining the magnitude of the transformed signals Y, Z and R and the phase of R, using the magnitudes of Y, Z and R to obtain a combined transformed signal R′ and reconstructing the time signal r′ using the magnitude of the combined transformed signal R′ and the phase of R. A dynamic echo suppressor of this type is described in United States Patent Application US 2003/0026437, the entire contents of which are herewith incorporated in this document.

As mentioned above, the adaptive filter of the central unit compensates the echoes that are caused by the loudspeakers of all speaker units and that reach the microphone(s) of the active speaker unit(s) mainly via reflections from walls. In the particularly advantageous embodiment of FIG. 4 the dynamic echo suppressor 27 removes any remaining echoes.

The speaker unit 3 of FIG. 5 also comprises an input 31, an output 32, a microphone 33, a loudspeaker 34, a switch 35 and an adaptive filter 36. In addition, the speaker unit of FIG. 5 is shown to comprise a update unit 37 for updating the filter coefficients of the adaptive filter 36. The functioning of the update unit 37 is in essence identical to the functioning of the functioning of the update unit 24 of the central unit 2 and need not be explained here.

It is noted that in use the adaptive filter 37 of any active speaker unit 3 is arranged substantially in parallel with both the adaptive filter 24 and the decorrelator 26 of the central unit 2. The advantages of incorporating the decorrelator 26 in the central unit 2 also hold true for the speaker unit 3.

To allow a quick adaptation of the speaker unit adaptive filter 36 it is preferred that is has a relatively short time span. The time span of a filter is defined as the product of the filter length (the number of delay units in a digital filter) and the sampling frequency. In a preferred embodiment, the filter has a time span between 20 ms and 45 ms, more in particular between 30 and 35 ms. It has been found that a time span of approximately 32 ms is particularly advantageous, however, other time span values may also be used. Such a relatively short time span causes the speaker unit adaptive filter 36 to only compensate echoes that are produced by the loudspeaker of the same speaker unit and the loudspeaker(s) of any adjacent speaker units. These echoes reach the microphone directly, or indirectly via reflections from nearby objects.

It is further advantageous when the central unit adaptive filter 23 has a greater time span than the speaker unit adaptive filter 36, in particular a significantly greater time span. It is preferred that the adaptive filter 23 of the central unit 2 has a time span between 125 and 500 ms, preferably between 200 and 300 ms. A time span of approximately 250 ms is particularly preferred. In this way, the central unit adaptive filter 23 is arranged for compensating diffuse echoes, that is, echoes from walls and other non-adjacent objects.

To allow a smooth transition from the AEC mode of the adaptive filter 36 when the speaker unit 3 is not active and the AFS mode when the speaker unit is active, it is preferred that the adaptation speed is made proportional to an estimate of the echo to non-echo (ENR) ratio of the microphone signal, provided that the ENR ratio does not exceed a certain threshold value. The adaptation speed of the filter may be adjusted by altering its step-size parameter, which is well known to those skilled in the art. The ENR may be estimated on the basis of the residual signal output by the combination unit 39 and the input signal of the adaptive filter 36, which signals are identical to the input signals of the update unit 37.

The update unit 37 may therefore contain an ENR (echo to non-echo) estimator for producing an ENR estimation signal, a comparator for comparing the ENR estimation signal to a (stored) threshold value which is, for example, equal to one, and circuitry for adjusting the adaptation speed of the adaptive filter to the ENR estimation signal if this signal does not exceed the threshold value. In such an embodiment it is achieved that the adaptive filter reacts relatively quickly when the microphone signal only contains echoes and that the adaptive filter reacts relatively slowly when the microphone signal contains the desired speech.

It is noted that the switch 35 may be constituted by a hand-operated switch, key or button, or by a remotely controlled electronic or electromechanical switch, such as a relay. The switch 35 may thus be directly or indirectly controlled, either by the delegate associated with the speaker unit or by a central unit or central control unit. In the latter case, a conference leader may remotely operate the switches 35.

It is further noted that in the above discussion it has been assumed that all signals are digital signals having certain values at a certain discrete point in time. However, the present invention is not so limited and analog embodiments can also be envisaged. Similarly, the present invention has been explained with reference to speaker units having a single microphone and a single loudspeaker, but the invention can also be applied using speaker units having multiple microphones and/or loudspeakers and/or equivalent transducers.

The present invention is based upon the insight that switching the loudspeaker of a conference system speaker unit on and off may lead to transients which cause signal distortion. The present invention benefits from the further insight that the loudspeaker may be permanently on if both the speaker unit and the central unit are provided with an adaptive filter.

It is additionally noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A conference system (1) comprising at least one speaker unit (3) and a central unit (2),
the at least one speaker unit (3) comprising an input (31) for receiving loudspeaker signals, an output (32) for supplying microphone signals, a loudspeaker (34) coupled to the input (31), an adaptive filter (36) coupled between the loudspeaker (34) and a combination unit (39), a microphone (33) coupled to the combination unit (39), and an activation device (35) coupled between the combination unit (39) and the output (34),
the central unit (2) comprising an input (21) for receiving microphone signals and an output (22) for supplying loudspeaker signals,
wherein the loudspeaker (34) of the at least one speaker unit (3) is permanently coupled to its input (31), and
wherein the central unit (2) is provided with a further adaptive filter (23) coupled between its input (21) and its output (22).

2. The conference system according to claim 1, wherein the central unit (2) further comprises a decorrelator (26).

3. The conference system according to claim 2, wherein the decorrelator (26) is constituted by a frequency shifter.

4. The conference system according to claim 1, wherein the central unit (2) further comprises a dynamic echo suppressor (27).

5. The conference system according to claim 1, wherein the adaptive filter (36) of the speaker unit (3) has a time span between 20 and 45 ms, preferably between 30 and 35 ms.

6. The conference system according to claim 1, wherein the adaptive filter (36) is arranged for having an adaptation speed which is substantially proportional to an estimate of an echo to non-echo ratio (ENR) in the microphone signal when the echo to non-echo ratio is lower than a certain threshold value, said threshold value preferably being equal to one.

7. The conference system according to claim 1, wherein the adaptive filter (23) of the central unit (2) has a time span between 125 and 500 ms, preferably between 200 and 300 ms.

8. The conference system according to claim 1, mounted in a vehicle.

9. A speaker unit (2) for use in the conference system (1) according to claim 1, the speaker unit comprising an input (31) for receiving loudspeaker signals, an output for supplying microphone signals, a loudspeaker (34) coupled to the input (31), an adaptive filter (36) coupled between the loudspeaker (34) and a combination unit (39), a microphone (33) coupled to the combination unit (39), and an activation device (35) coupled between the combination unit (39) and the output (34),
wherein the loudspeaker (34) is permanently coupled to the input (31).

10. A central unit (2) for use in the conference system (1) according to claim 1, the central unit comprising an input (21) for receiving microphone signals, an output (22) for supplying loudspeaker signals, and a further adaptive filter (23) coupled between its input and its output.

11. The central unit according to claim 10, further provided with a decorrelator (26), a dynamic echo suppressor (27) and/or an amplifier (28).
